(19) United States
(12) Patent Application Publication
(10) Pub. No.: US 2026/0310353 A1
(43) Pub. Date: Oct. 8, 2026

(54) SYSTEMS AND METHODS FOR LIMITING DATA STORAGE REQUIREMENTS OF NEURAL NETWORKS

(71) Applicant: ADVANCED MICRO DEVICES, INC., Santa Clara, CA (US)

(72) Inventors: HaiFeng Zhou, Shanghai (CN); Yung-Chiu Liu, Hsinchu (TW); Yi-Han Hsu, Hsinchu (TW); Yu-An Wei, Hsinchu (TW)

(21) Appl. No.: 19/098,566

(22) Filed: Apr. 2, 2025

(51) Int. Cl. G06F 3/06

(52) U.S. Cl. CPC G06F 3/0611; G06F 3/0656; G06F 3/0673

(57) ABSTRACT

A split, sequential convolution method limits memory requirements for neural networks, such as convolutional neural networks (CNNs), by reducing temporal computational complexity and serializing operations. For example, a processor subdivides a plurality of channels in the input feature data for the CNN into groups of intermediate channels and processes each individual, subdivided group of intermediate channels sequentially rather than processing all of the channels simultaneously. Another method limits system memory accesses and improves overall efficiency by storing intermediate results in a buffer. For example, a processor limits data storage requirements of neural networks by storing intermediate outputs of convolutions configured to process input feature data in a local buffer rather than in system memory.

### BACKGROUND

Parallel processors such as accelerator processors, neural network processing units (NPUs), and graphics processing units (GPUs) conventionally implement graphics processing pipelines that concurrently process copies of commands that are retrieved from a command buffer. GPUs and other multithreaded processing units typically implement multiple processing elements (which may include processor cores, compute units, chiplets, or workgroup processors) that execute different programs or concurrently execute multiple instances of a single program on multiple data sets as a single “wave,” i.e., a group of threads running concurrently on a GPU. A hierarchical execution model is typically used to match the hierarchy implemented in hardware.

The execution model defines a kernel of instructions that are executed by one or more waves (also referred to as wavefronts, which may include one or more threads, streams, tasks, or work items). The graphics pipeline in a conventional GPU includes one or more shader engines that execute computer programs typically referred to as “shaders” using resources of the graphics pipeline such as compute units, memory, and caches. GPUs are traditionally used for graphical calculations, as implied by their name; however, in modern computing, shaders are often utilized as “compute shaders,” which function as general-purpose software that is able to perform work separately from a graphics processing pipeline. As GPU usage and machine learning applications have expanded over time, there is a necessity to improve the functionality and performance of GPUs.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system limiting data storage requirements of neural networks according to some implementations.

FIG. 2 is a flow diagram of a method of limiting data storage requirements of neural networks according to some implementations.

FIG. 3 is a block diagram of an example of components of the processing system of FIG. 1 executing the method of FIG. 2.

FIG. 4 is a flow diagram of another method of limiting data storage requirements of neural networks according to some implementations.

FIG. 5 is a flow diagram of yet another method of limiting data storage requirements of neural networks according to some implementations.

### DETAILED DESCRIPTION

A parallel processor such as an accelerated processing device or graphics processing unit (GPU) typically includes a plurality of “shader engines,” where each shader engine includes a respective quantity of compute units, and a command processor (CP) coupled to the plurality of shader engines. The CP receives one or more commands for execution and generates the plurality of workgroups or tasks (e.g., processing threads or collections of threads corresponding to one or more programs) based on the one or more commands. Assigning each workgroup to a respective shader engine may include dynamically assigning each workgroup to a respective shader engine via an interface such as a shader program interface, which acts as a scheduler, associated with the respective shader engine.

As GPU usage for executing compute shaders, machine learning applications, and other general-purpose applications has expanded over time, in order to provide a GPU with the flexibility to execute tasks related to a graphics processing pipeline, machine learning, or other advanced computing applications in an efficient manner, GPUs implemented in accordance with the teachings of the present disclosure include a plurality of parallel processing chiplets (PPCs). In some implementations, the PPCs are configured to process tasks and function as advanced GPU chiplets in that they offer one or more of parallel processing functionality, optimized GPU functionality, and optimized processing for advanced applications that utilize, e.g., reduced precision data common in machine learning. The PPCs are able to execute instructions separately or in parallel and, in some implementations, share a single pool of virtual and physical memory with extremely low latency.

However, when a processor such as a PPC executes a neural network such as a convolutional neural network (CNN), the required number of memory accesses can introduce significant delays into the processing time and the amount of memory required to perform the convolutions can be excessive, particularly for lightweight implementations, e.g., on mobile devices. A CNN processes input feature data, such as one or more images comprising one or more channels, such as colors or hues, by extracting and learning hierarchical features through layers. The input image is passed through convolutional layers as a processor “slides” small filters or “kernels” across the input feature data to detect patterns such as edges, textures, and shapes. These detected features are often passed to deeper or other neural network layers for more complex pattern recognition. Convolutions typically perform element-wise multiplications between the kernel and a portion of the input feature data and sum the results to create feature maps or generate output feature data. The kernel is a small matrix of weights, learned during training, that acts as a feature detector. The bottleneck presented by increased processing time associated with numbers of memory accesses can increase the amount of time the convolutions take to execute, reduce overall throughput, and decrease the efficiency of performing the convolutions, while high memory requirements can prevent energy efficient operation. These limitations are often unacceptable in situations where limited power is available, limited memory is available, or storage requirements (e.g., number of accesses and/or capacity) of neural networks are otherwise desired to be minimized.

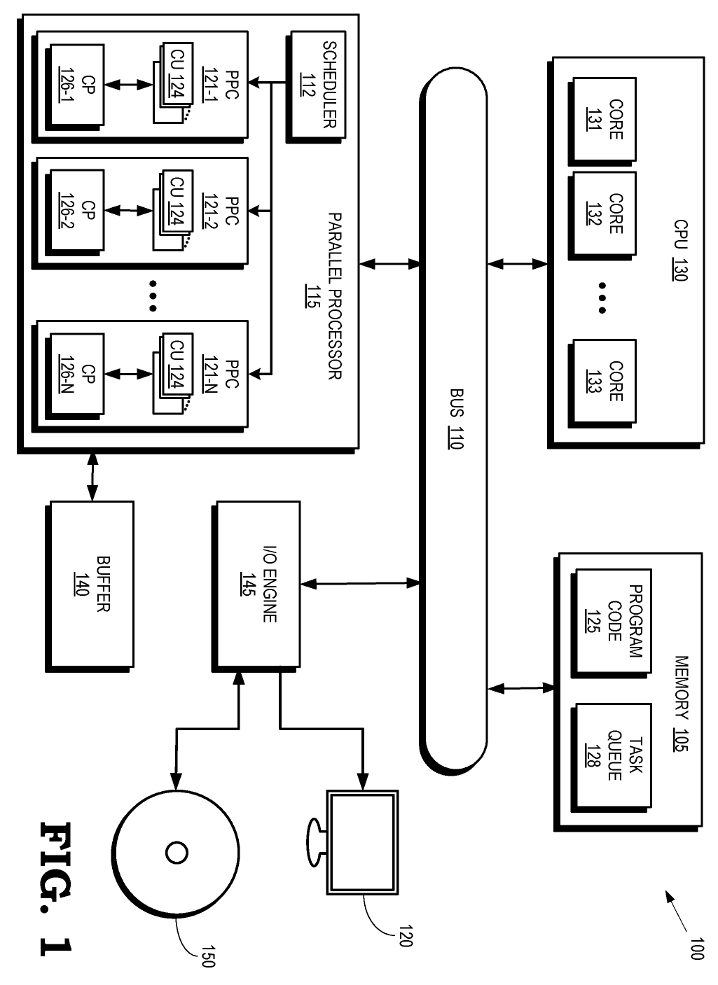

FIGS. 1-4 illustrate systems and techniques for limiting data storage requirements of neural networks. In some implementations, a split, sequential convolution method limits memory requirements for neural networks, such as CNNs, by reducing temporal computational complexity and serializing operations. In some implementations, a neural network limits system memory accesses and improves overall efficiency by storing intermediate results in a buffer. In order to reduce latency, in some implementations, a processor includes or is located proximal to the buffer such that the buffer has a lower read or write latency than system memory. The processor stores intermediate outputs of convolutions configured to process input feature data in a CNN in the buffer, which can reduce access counts to system memory for executing neural networks to about 8% of the access counts that may be otherwise required without the buffer. In some implementations, the processor subdivides a plurality of channels in the input feature data for a CNN into groups of intermediate channels. By processing each individual, subdivided group of intermediate channels sequentially using convolution operators configured to process the input feature data rather than processing all of the channels simultaneously, the amount of data storage required to execute a neural network can be significantly reduced (e.g., to about 33% of the storage that may be otherwise required) compared to simultaneously processing all of the input feature data.

FIG. 1 is a block diagram of a processing system 100 limiting data storage requirements of neural networks according to some implementations. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some implementations of the processing system 100 include other buses, bridges, switches, routers, and the like, which are not shown in FIG. 1 in the interest of clarity.

The techniques described herein are, in different implementations, employed at any of a variety of parallel processors (e.g., vector processors, GPUs, NPUs, general-purpose GPUs (GPGPUs), non-scalar processors, highly parallel processors, artificial intelligence (AI) processors, inference engines, machine learning processors, other multithreaded processing units, and the like). FIG. 1 illustrates an example of a parallel processor 115, which is implemented in the illustrated example as a multi-chiplet processor, in accordance with some implementations. In some implementations, the parallel processor 115 renders images for presentation on a display 120. For example, the parallel processor 115 renders objects to produce values of pixels that are provided to the display 120, which uses the pixel values to display an image that represents the rendered objects. However, the parallel processor 115 is also capable of executing software not directly involved in any graphics processing pipeline, such as machine learning applications and other advanced computing applications.

In order to provide the parallel processor 115 with the flexibility to execute tasks related to a graphics processing pipeline, machine learning, or other advanced computing applications in an efficient manner, the parallel processor 115 includes a plurality of PPCs, such as PPCs 121-1, 121-2, and 121-N, which are configured to process tasks and offer one or more of GPU functionality and optimized processing for advanced applications that utilize, e.g., reduced precision data common in machine learning. By providing the parallel processor 115 with a plurality of PPCs 121, the parallel processor 115 is able to perform a number of tasks simultaneously while latency and data transfer energy between the PPCs 121 is minimized. The PPCs 121 are typically implemented using shared hardware resources of the parallel processor 115, such as compute units 124. In some implementations, the PPCs 121 are used to implement shaders, such as geometry shaders, pixel shaders, and the like. Generally, the PPCs 121 are a logical grouping of processing hardware, which in some implementations includes, e.g., one or more processing chiplets, cores, multiply-accumulators (MAC), and/or caches. The PPCs 121 typically include or access a number of compute units 124 in the parallel processor 115, and each of the compute units 124 typically includes a number of single-instruction-multiple-data (SIMD) units. The number of PPCs 121 implemented in the parallel processor 115 is a matter of design choice and some implementations of the parallel processor 115 include more or fewer PPCs than are shown in FIG. 1.

In some implementations, the processing system 100 also includes a CPU 130 that is connected to the bus 110 through which it communicates with the parallel processor 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some implementations include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics or other processing by issuing draw calls or other tasks to the parallel processor 115.

In some implementations, as shown in the example of FIG. 1, the PPCs 121 each include a CP 126, such as CPs 126-1, 126-2, and 126-N, to manage and facilitate execution of incoming instructions or tasks. Tasks are stored in a task queue 128 in the memory 105, which also stores dependency information related to the tasks. In some implementations, the task queue 128 is duplicated or instead stored in the parallel processor 115 and/or CPU 130. Generally, the task queue 128 is stored in a location accessible by the CPU 130 and the parallel processor 115 so that the status of the tasks and dependency information in the task queue 128 can be monitored and new tasks and dependency information can be added as needed by, e.g., the CPU 130 or the parallel processor 115. In some implementations, the task queue 128 is implemented as a circular buffer with associated read and write pointers, but in other implementations the task queue 128 takes other forms such as an ordered list or cache.

As shown in FIG. 1, the parallel processor 115 further includes a scheduler 112, sometimes referred to as a sequencer, which is implemented as any cooperating collection of hardware, software, or a combination thereof that performs functions and computations associated with assigning threads, workgroups, waves, or other tasks, such as compute shader threads, to one or more of the PPCs 121. In some implementations, one or more schedulers or sequencers are incorporated into one or more PPCs, compute units 124, and/or CPs 126. In some implementations, one or more of the PPCs 121 are able to be selectively addressed or controlled independently from one another or addressed or controlled in groups of two or more such that the parallel processor 115, the scheduler 112, and/or a user is able to control which PPCs 121 perform specific tasks or to distribute tasks across a number of PPCs 121. In some implementations, the parallel processor 115 is used for general purpose computing. The parallel processor 115 executes instructions such as program code 125 stored in the memory 105 based on dependency information stored in the task queue 128, and the parallel processor 115 stores information in the memory 105 such as the results of the executed instructions, new dependency information for tasks, and indications that dependencies have been satisfied, e.g., when tasks associated with dependency information have finished executing.

In some implementations, the scheduler 112 and the CPs 126 work together or in parallel to process tasks and dependency information from the task queue 128. For example, in some implementations, the scheduler 112 assigns tasks to the compute units 124, and the compute units 124 interface with the task queue 128 to determine when tasks can be executed out of order based on dependency information specified in the task queue 128. In some implementations, the scheduler 112 interfaces with the task queue 128 to determine which tasks to assign to the compute units 124 based on the dependency information. Accordingly, in some implementations, the scheduler 112 and compute units 124 work together to ensure maximum parallelization and optimized throughput of task execution in the parallel processor 115.

In some implementations, at least one of the system 100, CPU 130, parallel processor 115, and PPCs 121 includes hardware and/or software configured to limit data storage requirements of neural networks, such as CNNs. In CNNs, spatial or pointwise convolutions and depthwise convolutions process data in different ways. Spatial convolutions involve applying a filter or kernel that spans all analyzed input channels while sliding across the height and width of the image. This operation captures complex spatial relationships by combining information across all channels, producing a single output channel for each filter. Instead of processing all input channels together, depthwise convolutions apply a separate filter to each channel independently. As such, depthwise convolutions can help detect spatial patterns within individual channels.

In some implementations, the parallel processor 115 includes or is associated with a buffer 140. In some implementations, one or more of the system 100, CPU 130, and/or the PPCs 121 include or are associated with the buffer 140 or a similar buffer. In some implementations, the buffer 140 enables at least one of the system 100, CPU 130, parallel processor 115, and/or PPCs 121 (e.g., one or more of the compute units 124 and/or CPs 126) to store intermediate outputs of convolutions configured to process input feature data in a CNN, which can significantly reduce access counts to system memory 105 for executing neural networks (e.g., to about 8% of the access counts that may be otherwise required without the buffer 140). In some implementations, at least one of the CPU 130, parallel processor 115, and/or PPCs 121 subdivide a plurality of channels of the input feature data for a CNN into groups of intermediate channels. For example, in some implementations, the plurality of channels of input feature data comprise color channels for a set of pixel data, such as pixels representing an image of a face, medical imagery, or one or more frames of surveillance or security footage. In some implementations, groups of intermediate channels are selected from the plurality of channels randomly, sequentially, or based on a priority level or priority threshold, where each channel is processed once. By processing each individual, subdivided group of intermediate channels sequentially using convolution operators configured to process the input feature data rather than processing all of the channels simultaneously, the amount of data storage required to execute a neural network can be significantly reduced (e.g., to about 33% of the storage that may be otherwise required without sequentially processing subdivided groups of intermediate channels).

An input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the parallel processor 115, or the CPU 130. In the illustrated implementation, the I/O engine 145 reads information stored on an external storage component 150, which is implemented using a non-transitory computer readable medium such as a compact disk (CD), a digital video disc (DVD), and the like. The I/O engine 145 is also able to write information to the external storage component 150, such as the results of processing by the parallel processor 115 or the CPU 130.

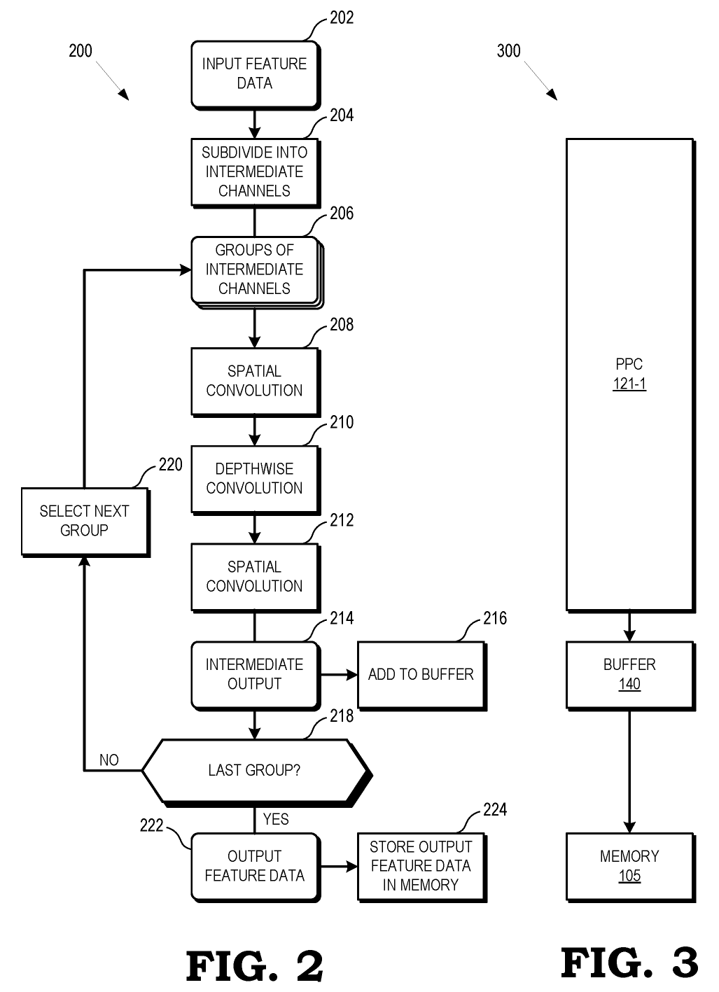

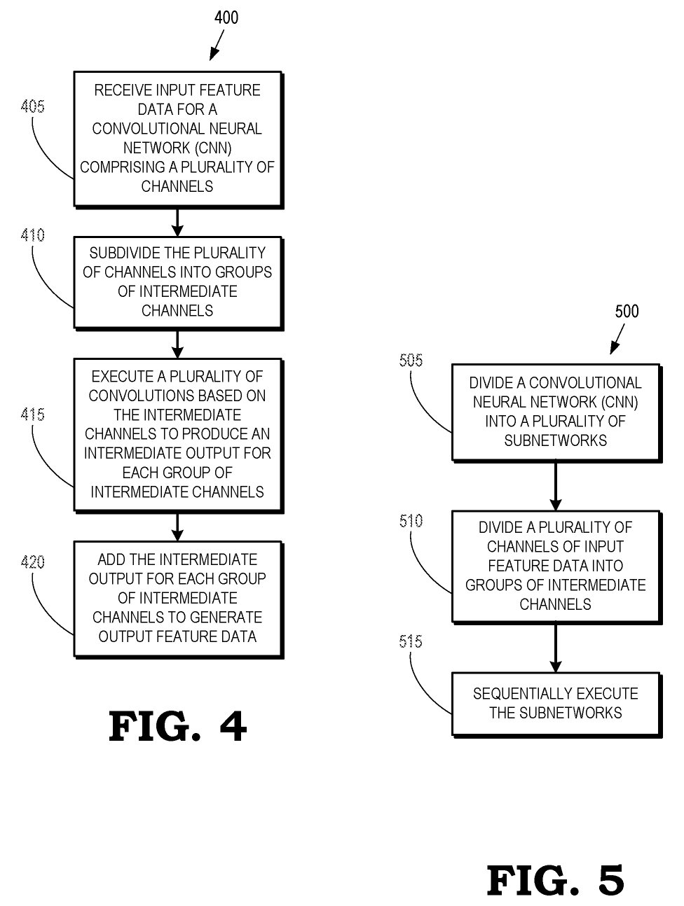

FIG. 2 is a flow diagram of a method 200 of limiting data storage requirements of neural networks according to some implementations. As noted above with reference to FIG. 1, in some implementations, at least one of the system 100, CPU 130, parallel processor 115, and PPCs 121 includes hardware, such as the buffer 140, and/or software configured to limit data storage requirements of neural networks. Examples of software limiting data storage requirements of neural networks are provided in FIG. 2, as well as in FIGS. 3 and 4, which are described further hereinbelow. In some implementations, a single processor executes the methods described, while in other implementations two or more processors execute portions of one or more of the methods sequentially, in parallel, or in a staggered order.

As shown in FIG. 2, at block 204 of the method 200, a processor in the system 100 subdivides a plurality of channels of input feature data 202 received for a CNN into groups of intermediate channels 206. In some implementations, the plurality of channels of input feature data 202 comprise different layers or channels of data representing a sound recording, sensor readings, or other data in which, e.g., a pattern or characteristic is desired to be identified. After subdividing the plurality of channels of input feature data 202 into groups of intermediate channels 206, a processor in the system 100 executes a plurality of convolutions based on the groups of intermediate channels 206 to produce an intermediate output for each group of intermediate channels 206.

For example, as shown in FIG. 2, in some implementations, at block 208, the processor executes a first spatial convolution for each intermediate channel of a group of intermediate channels 206 to produce convolutional feature data. In some implementations, the first spatial convolution executes, e.g., pointwise convolutions with a 1x1 kernel to extract a richer set of feature data from each intermediate channel of a group 206 in the input feature data 202. At block 210, the processor executes a depthwise convolution on the convolutional feature data to produce depth feature data. In some implementations, the depthwise convolution executes, e.g., convolutions with a 3x3 or 5x5 kernel across each intermediate channel of a group 206 in the input feature data 202. At block 212, the processor executes a second spatial convolution on the depth feature data to produce an intermediate output for each group of intermediate channels. In some implementations, the second spatial convolution executes, e.g., pointwise convolutions with a 1x1 kernel to project channels generated by the depthwise convolution executed at block 210 onto a new channel space.

At block 216, the processor adds the intermediate output 214 for each group of intermediate channels 206 to the system memory 105 or the buffer 140 as intermediate output feature data. At block 218, the processor determines whether the last group of intermediate channels 206 has been processed. If not, at block 220, the processor selects the next group of intermediate channels 206 and performs a further plurality of convolutions. However, when the last group of intermediate channels 206 has been processed, at block 224, the processor stores the final accumulated intermediate output feature data as output feature data 222 in a memory, such as the system memory 105 or the buffer 140.

By processing each individual, subdivided group of intermediate channels 206 sequentially using convolution operators configured to process the input feature data rather than processing all of the channels simultaneously, the amount of data storage required to execute a neural network can be significantly reduced (e.g., to about 33% of the storage that may be otherwise required without sequentially processing subdivided groups of intermediate channels). Accordingly, in some implementations, the plurality of convolutions for a first group of intermediate channels are executed prior to executing the plurality of convolutions for a second group of intermediate channels. As such, in some implementations, the adding at block 216 includes adding an intermediate output of the plurality of convolutions for the second group of intermediate channels to an intermediate output of the plurality of convolutions for the first group of intermediate channels prior to executing the plurality of convolutions for a third group of intermediate channels. However, in some implementations, the addition at block 216 is performed in parallel with any subsequent convolutions. Additionally, in some implementations, convolutions for groups of intermediate channels are executed in parallel with convolutions for a second group of intermediate channels using, e.g., multiple parallel processors and/or two or more PPCs 121.

In some implementations, the processor discards at least a portion of the input feature data 202 after producing each intermediate output 214. For example, when processing the groups of intermediate channels 206 sequentially, each individual group may only require a subset of the input feature data 202, such as a subset of pixels, in order to perform required convolutions. As such, in some implementations, after processing an individual group of intermediate channels 206, a portion of the input feature data 202 that is not required for executing subsequent convolutions is discarded to minimize the amount of memory required to execute the overall method 200.

FIG. 3 is a block diagram of an example 300 of components of the processing system of FIG. 1 executing the method of FIG. 2. As described above, any one or more tasks described herein is executable by any one or more of the CPU 130, parallel processor 115, and PPCs 121 of FIG. 1. However, as shown in FIG. 3, in some implementations, PPC 121-1 executes the majority of the tasks of the method 200 of FIG. 2. As indicated in FIG. 3 by its location relative to blocks of FIG. 2, in some implementations, PPC 121-1 executes at least blocks 204, 208, 210, and 212 of the method 200 of FIG. 2. Accordingly, the PPC 121-1 subdivides the input feature data 202 into groups of intermediate channels 206, performs a number of convolutions as shown in FIG. 2, and stores intermediate outputs in the buffer 140 or memory 105. After all of the groups 206 are processed, the PPC 121-1 stores the final output feature data 222 in the memory 105.

FIG. 4 is a flow diagram of another method 400 of limiting data storage requirements of neural networks according to some implementations. At block 405 of the method 400, a processor in the system 100 executes a plurality of convolutions based on a first set of input feature data and a first set of coefficients (i.e., weights or filters) to produce a first intermediate output. At block 410, the processor stores the first intermediate output in the buffer or memory. At block 415, the processor discards at least a portion of the first set of input feature data. At block 420, the processor executes a plurality of convolutions based on a second set of input feature data to produce a second intermediate output, wherein the second set of input feature data includes at least a portion of the first set of input feature data. As described above, in some implementations, the processor is further configured to execute a first spatial convolution on a first set of input feature data to produce convolutional feature data, wherein the first set of input feature data comprises a first set of pixels. The processor then executes a first depthwise convolution on the convolutional feature data to produce depth feature data and subsequently executes a second spatial convolution on the depth feature data to produce the first intermediate output.

FIG. 5 is a flow diagram of yet another method 500 of limiting data storage requirements of neural networks according to some implementations. At block 505 of the method 500, a processor in the system 100 divides a CNN into a plurality of subnetworks (e.g., groups of convolutions such as those shown in FIG. 2 at block 208, block 210, and block 212). At block 510, the processor divides a plurality of channels of input feature data into groups of intermediate channels. At block 515, the processor sequentially executes the subnetworks, wherein each subnetwork processes one of the groups of intermediate channels. In some implementations, the number of subnetworks is equal to the number of groups. In some implementations, the processor generates an output, such as the output feature data 222 of FIG. 2, based on a sum of outputs from each subnetwork.

In some implementations, the apparatus and techniques described above are implemented in a system including one or more integrated circuit (IC) devices (also referred to as integrated circuit packages or microchips), such as the CPU 130, parallel processor 115, and PPCs 121 described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some implementations, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” “engines,” “workgroups,” “launchers,” “interfaces,” “chiplets,” etc.) are described or claimed as “configured” to perform one or more tasks or operations. This formulation of “[entity] configured to [perform one or more tasks]” is used herein to refer to structure (e.g., a physical element, such as electronic circuitry, or an algorithm in software executed by such a physical element). More specifically, this formulation is used to indicate that this physical structure is arranged to perform the one or more tasks during operation. A structure can be said to be “configured to” perform some task even if the structure is not currently being operated. Thus, an entity described or recited as “configured to” perform some task refers to a physical element, such as a device, circuitry, memory storing program instructions executable to implement the task, or an algorithm executed using such a physical element. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific implementations. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific implementations. However, the benefits, advantages, solutions to problems, and any feature(s) that may cause any benefit, advantage, or solution to occur or become more pronounced are not to be construed as a critical, required, or essential feature of any or all the claims. Moreover, the particular implementations disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular implementations disclosed above may be altered or modified and all such variations are considered within the scope of the disclosed subject matter. Accordingly, the protection sought herein is as set forth in the claims below.

What is claimed is:

1. A method, comprising:
receiving input feature data for a convolutional neural network (CNN) comprising a plurality of channels;
subdividing the plurality of channels into groups of intermediate channels;
executing a plurality of convolutions based on the intermediate channels to produce an intermediate output for each group of intermediate channels; and
adding the intermediate output for each group of intermediate channels to generate output feature data.

2. The method of claim 1, wherein executing a plurality of convolutions comprises:
executing a first spatial convolution for each intermediate channel of a group to produce convolutional feature data;
executing a depthwise convolution on the convolutional feature data to produce depth feature data; and
executing a second spatial convolution on the depth feature data to produce an intermediate output for each group of intermediate channels.

3. The method of claim 1, wherein the plurality of convolutions for a first group of intermediate channels are executed prior to executing the plurality of convolutions for a second group of intermediate channels.

4. The method of claim 3, wherein the adding comprises adding an intermediate output of the plurality of convolutions for the second group of intermediate channels to an intermediate output of the plurality of convolutions for the first group of intermediate channels prior to executing the plurality of convolutions for a third group of intermediate channels.

5. The method of claim 1, further comprising storing the intermediate output for each group of intermediate channels at a buffer.

6. The method of claim 1, further comprising discarding at least a portion of the input feature data after producing each intermediate output.

7. The method of claim 1, wherein the input feature data comprises a set of pixels.

8. A system, comprising:
a buffer; and
a processor configured to:
execute a plurality of convolutions based on a first set of input feature data to produce a first intermediate output;
store the first intermediate output in the buffer;
discard at least a portion of the first set of input feature data; and
execute a plurality of convolutions based on a second set of input feature data to produce a second intermediate output, wherein the second set of input feature data includes at least a portion of the first set of input feature data.

9. The system of claim 8, wherein the processor is further configured to:
execute a first spatial convolution on a first set of input feature data to produce convolutional feature data, wherein the first set of input feature data comprises a first set of pixels;
execute a first depthwise convolution on the convolutional feature data to produce depth feature data; and
execute a second spatial convolution on the depth feature data to produce the first intermediate output.

10. The system of claim 8, wherein the buffer is located in the processor.

11. The system of claim 8, further comprising adding the first intermediate output and the second intermediate output to generate output feature data.

12. The system of claim 11, further comprising storing the output feature data in the buffer.

13. The system of claim 12, further comprising writing the output feature data to memory.

14. A method comprising:
dividing a convolutional neural network (CNN) into a plurality of subnetworks;
dividing a plurality of channels of input feature data into groups of intermediate channels; and
sequentially executing the subnetworks, wherein each subnetwork processes one of the groups of intermediate channels.

15. The method of claim 14, wherein the number of subnetworks is equal to the number of groups.

16. The method of claim 14, further comprising generating an output based on a sum of outputs from each subnetwork.

17. The method of claim 16, further comprising storing the output in a buffer.

18. The method of claim 14, further comprising discarding at least a portion of the input feature data after executing the subnetworks for each group of intermediate channels.

19. The method of claim 14, wherein sequentially executing the subnetworks comprises:
executing a first spatial convolution for each intermediate channel of a group to produce convolutional feature data;
executing a depthwise convolution on the convolutional feature data to produce depth feature data; and
executing a second spatial convolution on the depth feature data to produce an intermediate output for each group of intermediate channels.

20. The method of claim 14, wherein the input feature data comprises a set of pixels.
